(19) United States
(12) Patent Application Publication
(10) Pub. No.: US 2022/0054333 A1
(43) Pub. Date: Feb. 24, 2022

(54) WHEELCHAIR SELECTIVELY ENGAGEABLE WITH HOVERBOARD

(71) Applicant: Dave Ziegler, Delafield, WI (US)

(72) Inventor: Dave Ziegler, Delafield, WI (US)

(21) Appl. No.: 16/997,534

(22) Filed: Aug. 19, 2020

(51) Int. Cl. A61G 5/04; A61G 5/12; A61G 5/10

(52) U.S. Cl. CPC A61G 5/047; A61G 5/045; A61G 5/1013; A61G 5/125; A61G 5/128

(57) ABSTRACT

A transportation device having a chassis which includes seat and back portions for an occupant, a drive frame portion, and an engagement frame portion. The drive frame portion includes a drive system, and is able to selectively the engagement frame portion. The hoverboard is able to selectively engage the engagement frame portion and electronically communicates with the drive system to bypass a gyroscope of the hoverboard. The chassis, including the drive frame portion, is able to selectively disengage with the engagement frame portion, while it is engaged to the hoverboard, for easier transportation.

### FIELD OF INVENTION

The present invention is an easily transportable electronic transportation device that selectively engages to a hoverboard, providing on-demand assistance, with shock-absorbing front wheels and height-adjustable handlebar for different heights of companions who will accompany the user.

### BACKGROUND

People, whether through birth defect, injury, or age, may require the use of a transportation device to be mobile like a wheelchair. This typically includes a frame, chair, and at least one set of wheels. There are two main types of wheelchairs: manual and electric. The manual wheelchair allows an occupant to either manually rotate the wheels using his hands to move both himself and the wheelchair or an assistant can push the wheelchair using the handles of the frame. A manually powered wheelchair, however, can be physically exhausting—especially when traveling uphill or over difficult terrain. Furthermore, many wheelchair users prefer to be pushed by their partner rather than operating a motorized version themselves. This gives them a sense of security and personal connection to their companion.

Electronically powered wheelchairs, on the other hand, are powered through a battery and allow an occupant to travel without having to manually turn the wheels or have someone else push the wheelchair. Electronically powered wheelchairs exist today at a higher price than the average consumer is able or willing to pay for a premium product. People whose health requires a powered transport chair have difficulty loading and unloading them in their vehicles due to their weight and size. Most electronically powered wheelchairs weigh more than 70 pounds. Due to weight of their wheelchairs, it is difficult to transport wheelchairs in vehicles unless the vehicle is especially modified for use with a wheelchair, which is expensive. Occupants of electronically powered wheelchairs are therefore forced to remain close to home, within an area determined by the length of time a battery can power their wheelchair. Occupants must ensure that their battery will not fail unexpectedly if they travel outside of their home. Occupants therefore cannot travel far outside of their home or find it difficult to do so unless their vehicle is specially modified for use with a wheelchair, which is also expensive.

It is therefore desirable for an electronically powered wheelchair to be economically priced and easily transportable to allow users to travel outside of their homes. It is further desirable an electronic wheelchair to be lighter weight, easier to transport, has a smaller footprint, and allows an improved quality of travel for the rider and caregiver than previously offered.

### SUMMARY OF THE INVENTION

The present invention discloses an electronically powered transportation device that resolves one or more of the shortcomings disclosed above.

One aspect of the present invention discloses an electronically powered, e-assist transportation device powered by hoverboard which is used on-demand by the companion who is pushing the transport chair. The transportation device further includes a drive system that bypasses a gyroscope within the hoverboard so that the transportation device does not need to be controlled through physical contact with the hoverboard.

Another aspect of the present invention includes a chassis that has a frame engagement portion and a drive frame portion that can be coupled together when using and decoupled when transporting it in the car. The drive frame portion and hoverboard may therefore be transported separately from the frame engagement portion of the chassis. This is a dramatic decrease in weight of the unit so it can be lifted into a car by most people.

Another aspect of the present invention includes a chassis that has a leg frame portion that connects to shock absorbing front wheels with suspension to improve ride quality and user safety.

Still another aspect of the present invention includes a chassis having a handle that is ergonomically shaped for easier use by the companion. It is further pivotally height adjustable to accommodate different heights of the companion. The handle also selectively pivots or folds for easier transportation.

### BRIEF DESCRIPTION OF THE FIGURES

A clear conception of the advantages and features constituting the present invention will become more readily apparent by referring to the exemplary, and therefore non-limiting, embodiments illustrated in the drawings accompanying and forming a part of this specification, wherein like reference numerals designate the same elements in the several views.

In the drawings:

FIG. 1 is an exploded rear perspective view of an electronically powered wheelchair in accordance with the present invention;

FIG. 2 is a front perspective view of a chassis of the electronically powered wheelchair of FIG. 1;

FIG. 3 is a rear perspective view of the chassis of FIG. 2;

FIG. 4 is a perspective view of a cover and a hoverboard disengaged;

FIG. 5 is a perspective view of the cover and hoverboard of FIG. 4 engaged;

FIG. 6 is a perspective view of the electronically powered wheelchair of FIG. 1 in a use position; and

FIG. 7 is a perspective view of the electronically powered wheelchair of FIGS. 1 and 6 in a transportation position.

### DETAILED DESCRIPTION

The present invention and the various features and advantageous details thereof are explained more fully with reference to the non-limiting embodiments described in detail in the following description.

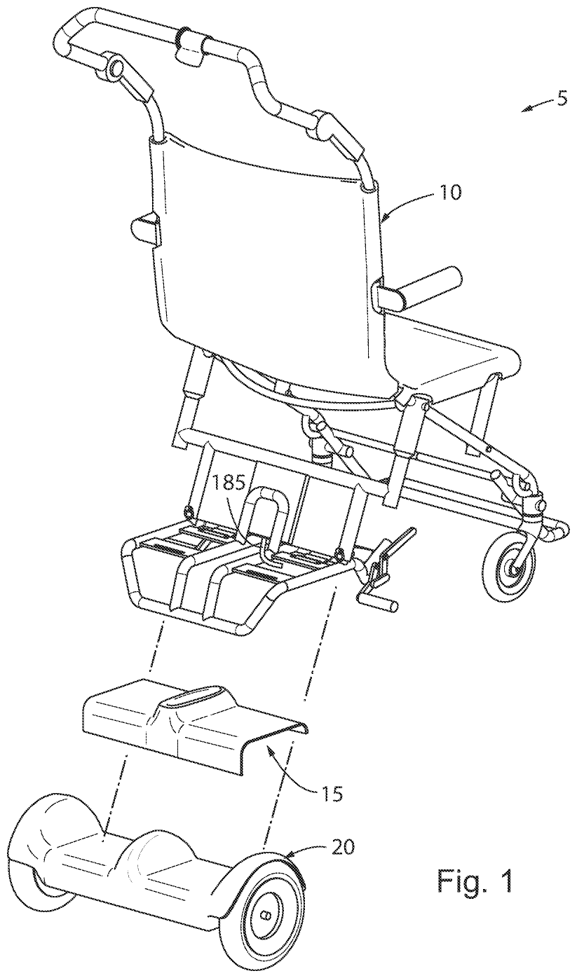

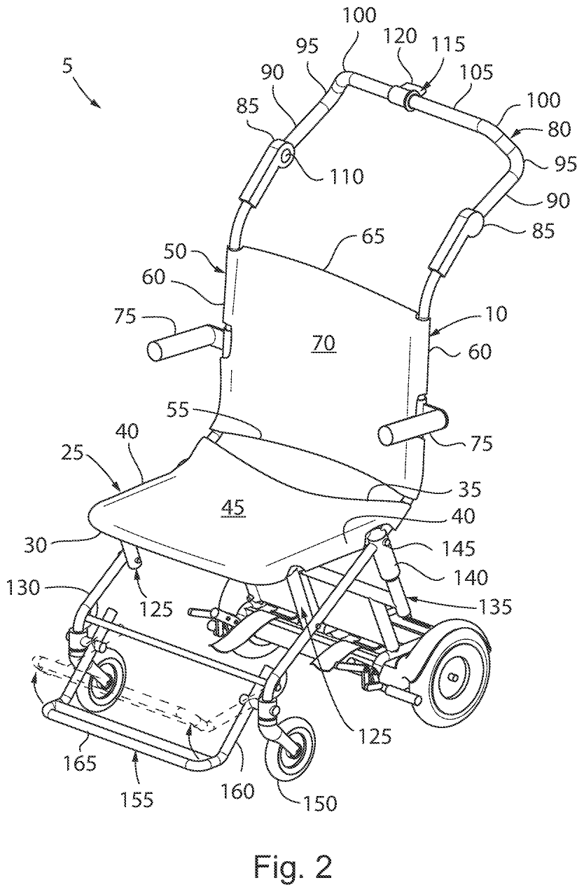

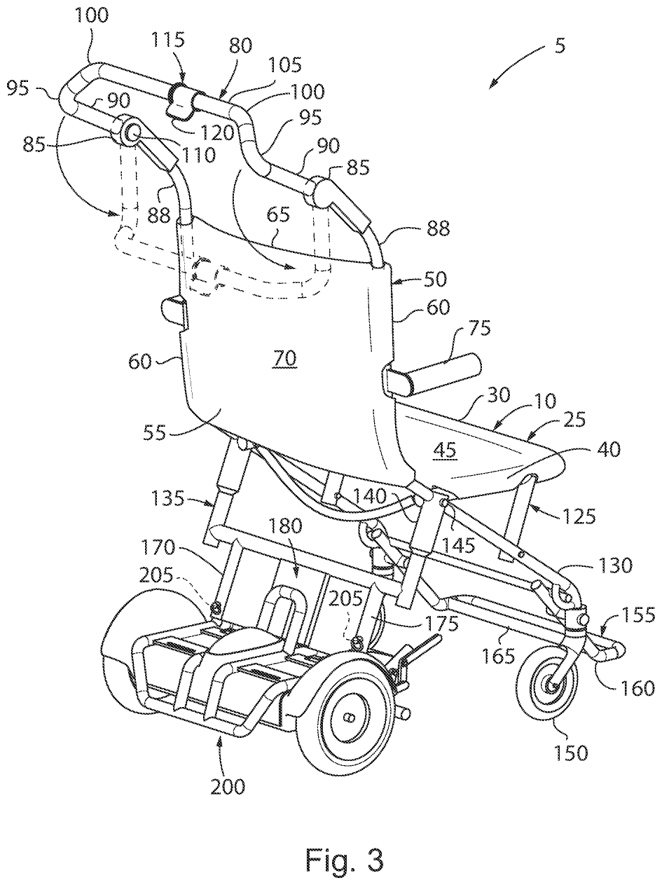

As illustrated in FIG. 1, an electronically powered transportation device 5, such as a wheelchair includes a frame or chassis 10, a cover 15, and a drive component or hoverboard 20 which may selectively engage each other, as will be described in detail hereinafter. Turning to FIGS. 2 and 3, the chassis 10 may be a lightweight frame that includes a seat portion 25, which has a front seat portion end 30 and a back seat portion end 35, located opposite from the front seat portion end 30. The front seat portion 30 and back seat portion end 35 are connected through seat side portions 40. In one embodiment, the seat portion 25 may be a solid piece or section that a wheelchair occupant can sit on. Alternatively, the seat portion 25 may include tubes, members, supports, or other structures (not shown) that extend across the front seat portion end 30, back seat portion end 35, and seat side portions 40 to form a rectangular-like shape. The seat portion 25 may further include a seat cover 45 that extends from the front seat portion 30 to back seat portion 35, as well as from seat side portion 40 to seat side portion 40 to create a surface for the transportation device 5 occupant to sit on.

The chassis 10 further includes a back portion 50 that extends upwards, away from the back seat portion end 35. More specifically, a lower back portion end 55 of the back portion 50 is adjacent to the back-seat portion end 35. The back portion 50 extends from the lower back portion end 55 to back side portions 60, located generally perpendicular to the lower back portion end 55, and finally to an upper back portion end 65 also located generally perpendicular to the back side portions 60 and opposite from the lower back portion end 55 Similarly, to the seat portion 25, the back portion 50 may be a solid section or piece that supports the back of the wheelchair occupant. Alternatively, the back portion 50 may include tubes, members, supports, or other structures (not shown) that extend across the lower back portion end 55, back side portions 60, and upper back portion end 65 to form a rectangular-like shape. The back portion 50 may further include a back cover 70 that extends from the lower back portion end 55 to the upper back portion end 65, as well as from one back side portion 60 to the other back side portion 60 to create a support surface for the wheelchair occupant to lean upon.

Together, the seat portion 25 and the back portion 50 form a L-like shape or a conventional portion of a chair which abuts the user when seated. The seat portion 25 and the back portion 50 are therefore each generally planar so that the seat portion 25 and back portion 50 may support the occupant. In alternative embodiments, the seat portion 25 and the back portion 50 may be curved and shaped to support the occupant more ergonomically. The seat portion 25 and/or back portion 50 may further be cushioned to be more comfortable for the occupant.

The chassis 10 also includes two arm rests 75, where each arm rest 75 extends generally perpendicular from the back side portions 60 and generally parallel to the seat side portions 40, and further positioned so that the occupant can place his arms on and be supported by the arm rest 75. In alternative embodiments, the arm rests 75 may be padded so that they are more comfortable for the occupant. The arm rests 75 may further be height adjustable. The chassis 10 further includes an ergonomic handle 80 that extends from pivot joints 85. Each pivot joint 85 may be located and positioned at the intersection of the upper back portion end 65 and back side portions 60, thereby connecting the handle 80 with the upper back portion end 65. Alternatively, the pivot joint 85 may be located and positioned so that the pivot joints 85 extend from a handle extender 88. The handle extender 88 may be a member extending from the back portion end 65. In one embodiment, the handle 80 may be a U-shaped bar. In more detail, the handle 80 may be further shaped so that the handle 80 includes handle arm portions 90 that project away from each pivot joint 85 and curve inwardly into handle concave portions 95. The handle concave portions 95 may then curve outwardly into the handle shoulder portions 100 before joining at a generally horizontal handle center portion 105.

The ergonomic handle 80 is more comfortable for an assistant when pushing the transportation device 5 because it allows the assistant's arms, wrists, and hands to be positioned naturally. Unlike when the arms, wrists, and/or hands are bent or twisted, natural arm, wrist, and hand positioning allows a person to use the same amount of energy and force to push the transportation device 5, and also reduces the likelihood of obtaining muscle injury. As illustrated in FIG. 3, the handle 80 can further be ergonomically adjusted by changing its height through the pivot joints 85. The handle 80 may be lowered or raised by actuating a button 110 of the pivot joint 85. When the button 110 is depressed, the handle 80 may be raised or lowered, by rotating around the pivot joint 85, according to the preference of the assistant. The button 110 is then released to lock and secure the handle 80 in its current position. The pivoting handle 80 also allows the handle 80 to be folded for easier transportation and storage.

The handle 80 further includes a controller 115 which may be located on the handle center portion 105 for easy access by the assistant pushing the transportation device 5. Other controller 115 locations on the handle 80 or transportation device 5 are envisioned and foreseeable. In one embodiment, the controller 115 includes a controller handle 120 that projects away from the controller 115. The controller handle 120 may be used to control if and the amount of assistance from a drive component or hoverboard 20 to power the transportation device 5, as will be explained in more detail hereinafter. In alternative embodiments, the controller 115 may include gears, buttons, and/or other control mechanisms to control the transportation device 5. In still other embodiments, the controller 115 may be located in other places on the transportation device 5, thereby allowing either the assistant or occupant to use the controller 115.

Turning back to FIG. 2, the chassis 10 further includes a support frame portion 125, a leg frame portion 130, and a drive frame portion 135. The support frame portion 125 is adjacent to and projects downwards from the seat portion 25, towards the ground, when the transportation device 5 is in a use position. The support frame portion 125 includes a series of frame sections 140 and pivot points 145 allowing the transportation device 5 to fold into a storage or transportation position for easier transportation as will be explained hereinafter. The support frame portion 125 is further adjacent to the leg frame portion 130, which projects away from the support frame portion 125, at the front seat portion end 30. In one embodiment, a wheel 150 (e.g., caster wheel) may be inserted into and engage each leg frame portion 130. The wheel 150 and leg frame portion 130 may engage each one another through a friction fit, threaded engagement, or snap engagement. Other engagement methods are envisioned and foreseeable. In one embodiment, the wheels 150 may be approximately two to four inches radius. The smaller wheels 150 allow the pushing force to be closer to the ground thereby causing less torsional rotation and reducing the likelihood that the transportation device 5 may tip forward. In yet another alternative embodiment, the wheel 150 may further include suspension (e.g., Frog Leg® wheels) to reduce jostling so that the transportation device 5 is more comfortable for the occupant.

The leg frame portion 130 of the chassis 10 is further adjacent to and pivotably engages a footrest portion 155. The footrest portion 155 may include footrest connection segments 160 that engage and extend adjacent from the leg frame portion 130, and footrest horizontal segments 165, that extend generally perpendicularly from and between the footrest connection segments 160. Further, the footrest portion 155 is shaped and sized so that the wheelchair occupant can place their feet on and be supported by the footrest horizontal segments 165. Additionally, the footrest connection segments 160 pivotably engage the leg frame portion 130 thereby allowing the footrest portion 155 to rotate upwards for storage or rotate downwards for use by the wheelchair occupant. In alternative embodiments, the footrest portion 155 may engage the support frame portion 125 (or both the leg frame portion 130 and support frame 115).

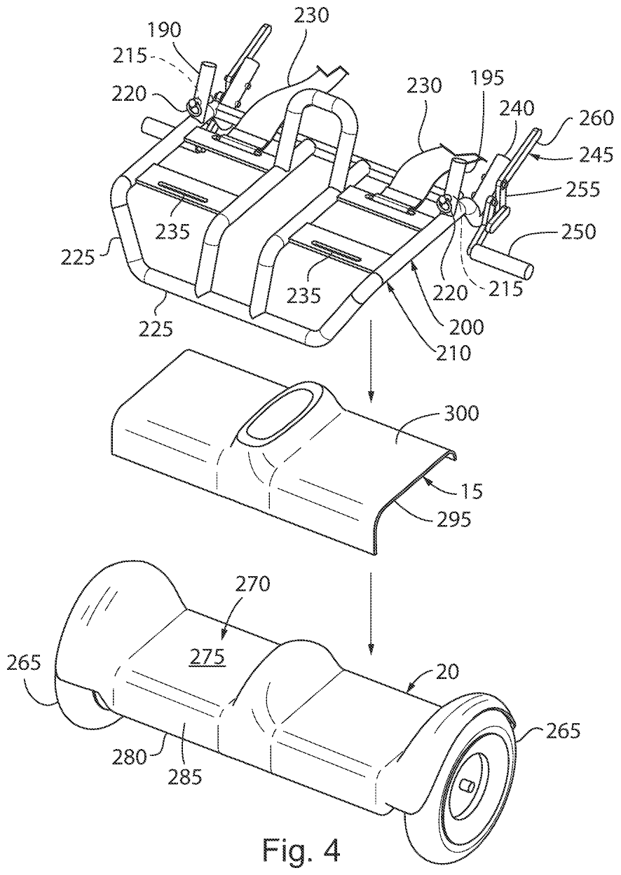

Referring to FIG. 3, the chassis 10 includes the drive frame portion 135 which extends downwards from the support frame portion 125, at the back seat portion end 35, opposite from the leg frame portion 130. In one embodiment, the drive frame portion 135 may include two frame segments 170 and 175, generally parallel to each other and project away from the support frame portion 125. The frame segments 170 may be hollow tubes or members, and may also be further located and positioned on opposite sides of a drive system 180, which includes a drive system cable 185 (shown in FIG. 1), extending from the drive system 180 and for electronic communication with the hoverboard 20 as will be explained hereinafter. Additionally, each frame segment 170 and 175 may be shaped and sized so that engagement frame segments 190 and 195 of an engagement frame portion 200 (shown in FIG. 4) may be inserted into and engage frame segment 170 and 175. Each frame segment 170 and 175 also includes a drive frame aperture 205, which assists in securing the drive frame portion 135 and engagement frame portion 200 together when the drive frame portion 135 and engagement frame portion 200 are selectively engaged, which will be explained in more detail hereinafter.

As illustrated in FIG. 4, the transportation device 5 further includes the engagement frame portion 200, which includes engagement frame segments 190 and 195, as well as a drive engagement frame segment 210. The engagement frame portion 200 includes engagement frame segments 190 and 195, which may be hollow tubes or members. The engagement frame segments 190 and 195 may extend from a drive engagement frame segment 210. In one embodiment, the engagement frame segments 190 and 195 may be positioned generally perpendicular or at an obtuse angle from the drive engagement frame segment 210. The engagement frame segments 190 and 195 may be shaped and size so that the engagement frame segments 190 and 195 may be inserted into frame segment 170 and 175. The engagement frame segments 190 and 195 may further include at least one engagement frame aperture 215. The engagement frame segments 190 and 195 may therefore be inserted into frame segments 170 and 175 to engage one another, thereby connecting the drive frame portion 135 and engagement frame portion 200 (as well as connecting the engagement frame portion 200 to the remainder of the chassis 10, as shown in FIG. 3). When the engagement frame segments 190 and 195 engage the frame segments 170 and 175, the drive frame aperture 205 and engagement frame aperture 215 align, allowing a pin 220 to be inserted into and extend through the drive frame aperture 205 of the frame segments 170 and 175 and the engagement frame aperture 215 of the engagement frame segments 190 and 195, thereby securing the frame segments 170 and 175 and the engagement frame segments 190 and 195 together. Other types of engagement methods, such as a friction, snap, or spring pin, may be are envisioned and may used in other embodiments.

The drive engagement frame segment 210 of the engagement frame portion 200 may be formed from a series of frame segments 225 that form a 90° or V-like shape thereby allowing the engagement frame portion 200 to selectively engage with the hoverboard 20. The engagement frame portion 200 further includes hook and loop straps 230 that are attached to the engagement frame portion 200, adjacent to the engagement frame segments 190 and 195. The engagement frame portion 200 also includes apertures, slits, or slots 235 located opposite from the hook and loop straps 230. The slots 235 is further shaped and sized so that each hook and loop strap 230 may extend through each slot 235 before folding back on itself to form a hook and loop engagement. In other embodiments, the straps 230 and/or slots 235 may be located in other areas of the engagement frame portion 200. The engagement frame portion 200 further includes at least one brake frame portion 240 and a brake 245 attached to the at least one brake frame portion 240. The brake 245 includes a brake pad 250 attached to a brake lever 255. In one embodiment, the brake pad 250 may be a member with the brake lever 255 located and positioned at one end of the brake lever 255 and a brake handle 260 located at the other end of the brake lever 255, opposite from the brake pad 250. The at least one brake frame portion 240 projects away from the drive engagement frame segment 210, and is further positioned so that the brake pad 250 of the brake 245 abuts a hoverboard wheel 265 when the brake 245 is engaged thereby slowing and stopping the transportation device 5 through friction.

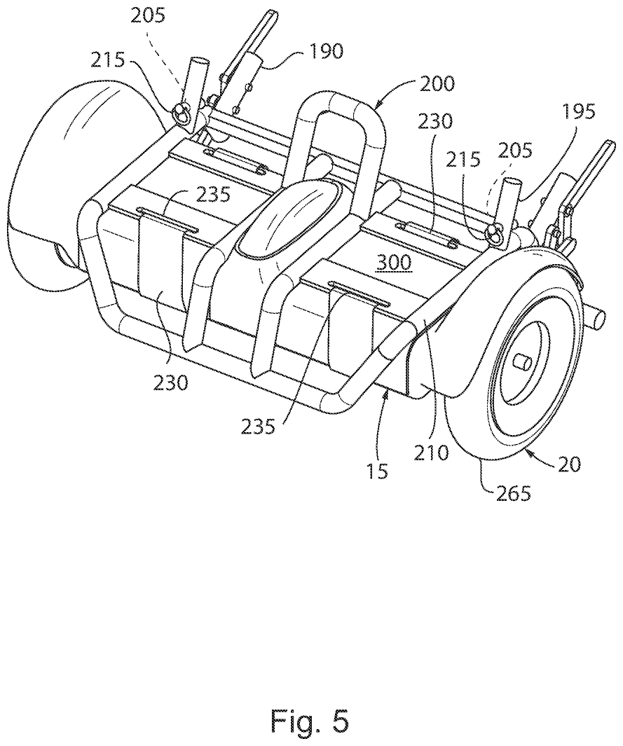

As illustrated in FIGS. 4 and 5, the transportation device 5 may also include the cover 15 and hoverboard 20, which may selectively engage each other. The hoverboard 20 is typical hoverboard as known in the art. The hoverboard 20 may include a platform 270, which includes an upper hoverboard surface 275 and a lower hoverboard surface 280. The upper hoverboard surface 275 and lower hoverboard surface 280 may be generally planar and connected through hoverboard side surfaces 285 which extend between the upper hoverboard surface 275 and lower hoverboard surface 280. A hoverboard 20 user typically places their feet on the upper hoverboard surface 275 to control the hoverboard 20. The platform 270 of the hoverboard 20 extends between two hoverboard wheels 265. In one embodiment, the hoverboard wheels 265 are air tires. The hoverboard 20 further includes a hoverboard port 290 (not shown).

The cover 15 may be a plastic covering shaped and sized to extend between the two hoverboard wheels 265 and over the upper hoverboard surface 275. A bottom cover face 295 of the cover 15 is therefore adjacent to and abuts the upper hoverboard surface 275, while an upper cover face 300 is located and positioned opposite from the bottom cover face 295. In one embodiment, the cover 15 may be substantially planar. In alterative embodiments, the cover 15 may extend past the upper hoverboard surface 275 and also cover at least a portion of the hoverboard side surfaces 285. In yet another embodiment, the cover 15 may include aperture(s) and/or protrusions depending on the shape and structure of the hoverboard 20. In still yet another embodiment, the cover 15 may be any shape and size as long as the cover 15 is able to protect the hoverboard 20 from damage when the hoverboard 20 is engaged with the engagement frame portion 200.

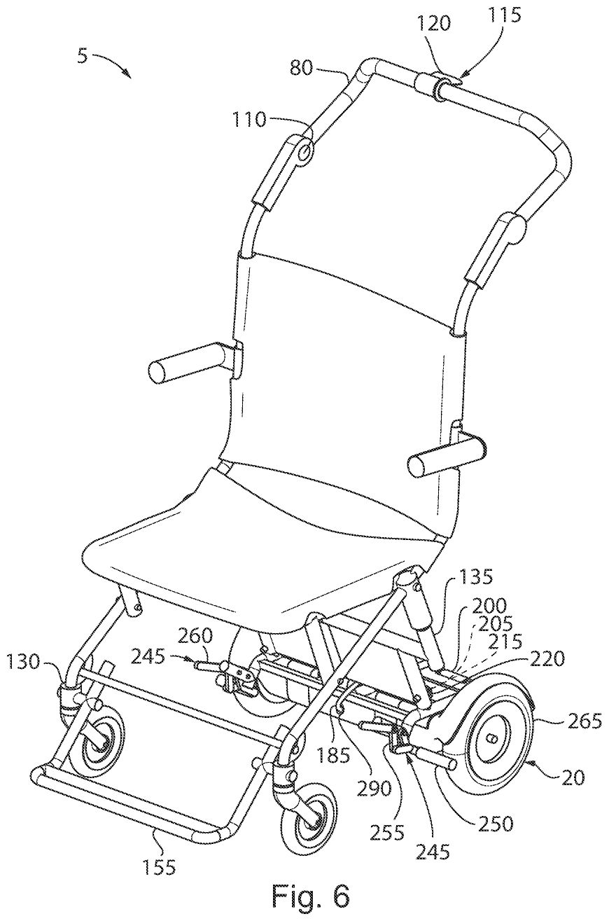

In an example embodiment and as shown in FIG. 5, the transportation device 5 may be placed in a first position or use position (shown in FIG. 6) by first placing the cover 15 onto the hoverboard 20, and then the engagement frame portion 200 may be placed onto both the cover 15 and hoverboard 20. The engagement frame portion 200 may be secured to the hoverboard 20 and cover 15 though a hook and loop engagement. In more detail, once the cover 15 has been placed onto the hoverboard 20, the engagement frame portion 200 may be placed onto both the cover 15 and hoverboard 20 so that the drive engagement frame segment 210 is adjacent to and abuts the upper cover face 300, while the bottom cover face 295 is adjacent to and abuts the upper hoverboard surface 275 (shown in FIG. 4). The hook and loop straps 230 of the engagement frame portion 200 may then be extended around the hoverboard side surface 285, under a bottom portion hoverboard surface 305, and over the other hoverboard side surface 285 (also shown in FIG. 4) before being inserted into and through the slot 235 and folded back so that the hook portion and loop portion of the hook and loop strap 230 are adjacent to and abut each other forming a hook and loop engagement. In other embodiments, the hoverboard 20 may engage the cover 15 through other methods.

Turning to FIGS. 3-6, the engagement frame segments 190 and 195 of the engagement frame portion 200 can then selectively engage the frame segments 170 and 175 of the drive frame portion 135 by inserting the engagement frame segments 190 and 195 into the frame segments 170 and 175, respectively (or vice versa in other embodiments). Frame segments 170 and 175 and engagement frame segments 190 and 195 each include at least one drive frame aperture 205 and engagement frame aperture 215, respectively, with each drive frame aperture 205 and engagement frame aperture 215 located and positioned so that they align with each other when the engagement frame portion 200 and drive frame portion 135 are selectively engaged. As illustrated in FIG. 6, a pin 220 can then be inserted into the apertures 205 and 215 to secure and retain the engagement frame portion 200 and drive frame portion 135 engagement. The drive system cable 185 may be inserted into the hoverboard port 290. The footrest portion 155 may be unfolded or rotated downwards. The transportation device 5 is then in a first or use position, as illustrated in FIG. 6.

The occupant can then sit on the transportation device 5 and the assistant can release the brake 245 by pushing the brake handle 260 downwards thereby rotating the brake lever 255 so that the brake pad 250 no longer abuts and engages the hoverboard wheels 265. The assistant can then adjust the handle 80 by pressing the button 110 and pivoting the handle 80 to lift or lower the handle 80 until the handle 80 is the desired height where the button 110 can then be released, thereby locking the handle 80 at its desired height. The assistant can then push the transportation device 5. If the assistant desires assistance in pushing the transportation device 5 and occupant, the assistant can actuate the controller handle 120 of the controller 115. In one embodiment, the greater the pressure the assistant uses to actuate the controller handle 120, the greater the amount of assistance the assistant receives from the hoverboard 20. The drive system 180 bypasses a gyroscope (not shown) within the hoverboard 20 and allows an asymmetrical amount of power directed towards the hoverboard wheels 265 when the transportation device 5 turns. The transportation device 5 can therefore smoothly turn left or right without needing to tilt or place more pressure on one side of the upper hoverboard surface 275. Without the drive system 180, either the transportation device 5 would struggle when turning due to the equal amount of power directed towards both hoverboard wheels 265 or the occupant would be forced to control the transportation device 5 through the hoverboard—by tilting or placing more pressure on the various portions of the hoverboard 20.

The assistant can also decrease the amount of power directed towards the hoverboard wheels 265 by placing less pressure on the controller handle 120 or letting go of the controller handle 120. The transportation device 5 then decelerates and eventually comes to a complete stop. The assistant can then engage the brake 245 to ensure the transportation device 5 does not roll away.

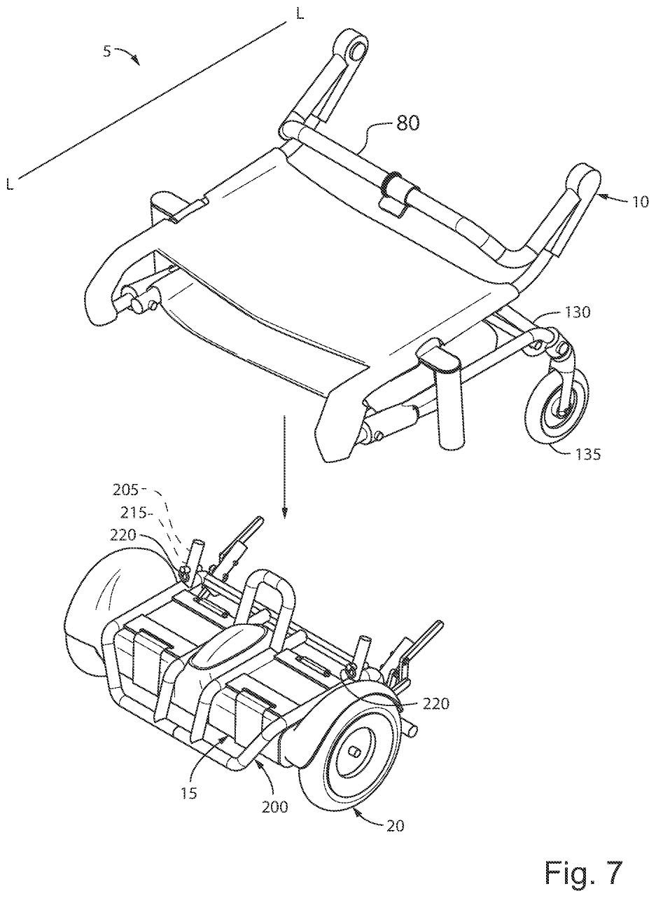

Referring to FIG. 7, in order to place the transportation device 5 in a second position, a storage position, or transportation position, the handle 80 can be folded downwards to reduce the amount of space needed to store the transportation device 5. Similarly, the footrest portion 155 (shown in FIG. 2) may also be folded upwards. Optionally, the wheels 150 can also be removed from the leg frame portion 130 (not shown). The pins 220 can be removed from apertures 205 and 215 so that the engagement frame portion 200 can be disengaged from the drive frame portion 135. The pins 220 may be placed back within either the drive frame aperture 205 or the engagement frame aperture 215 to reduce the likelihood of the pins 220 from being lost. Once the hoverboard 20, cover 15, and engagement frame portion 200 have been removed from the chassis 10, the chassis 10 can be folded along a longitudinal axis L, as illustrated in FIG. 7. The engagement frame portion 200, hoverboard 20, and cover 15 can be carried and transported separately from the remainder of the chassis 10. The engagement frame portion 200 can optionally further be removed from the cover 15 and hoverboard 20 to further reduce the weight (as shown in FIG. 4). The transportation device 5 may weigh approximately 60 pounds when in a use position. However, with the engagement frame proportion 200, hoverboard 20, and cover 15 disengaged from the chassis 10, the chassis 10 may weigh approximately 25 pounds while the engagement frame portion 200, hoverboard 20, and cover 15 may weigh 35 pounds. The transportation device 5 may therefore be partially dissembled so that it is lighter and easier to transport.

While most electric wheelchairs weigh 70+ pounds, this transport chair easily separates without tools into two lightweight pieces, each less than 35 pounds. Its front-to-back foldable/collapsible design is lighter weight, easier to transport, has a smaller footprint, and allows an improved quality of travel for the rider and caregiver than previously offered. The new transport device 5 also gives the caregiver the option to push the transport chair manually or to engage an on-demand e-assist motor for more strenuous outings such as steep inclines, uneven surfaces, or long distances.

In alternative embodiments, the transportation device 5 may be a stroller where the hoverboard 20 can replace the rear wheels. The hoverboard 20 can then selectively assist in helping the assistant, parent, or guardian in pushing the child or children similarly to the example of a wheelchair as a transportation device 5 as described above.

It should be understood that the above description, while indicating representative embodiments of the present invention, is given by way of illustration and not of limitation. Many changes and modifications may be made within the scope of the present invention without departing from the spirit thereof, and the invention includes all such modifications.

Various additions, modifications, and rearrangements are contemplated as being within the scope of the following claims, which particularly point out and distinctly claim the subject matter regarding as the invention, and it is intended that the following claims cover all such additions, modifications, and rearrangements.

We claim:

1. A transportation device comprising:
a chassis having a handle and a drive system;
a hoverboard;
wherein the drive system bypasses a gyroscope of a hoverboard; and
wherein the hoverboard selectively engages with the chassis.

2. The transportation device of claim 1 wherein the chassis includes a seat portion and a back portion.

3. The transportation device of claim 1 wherein the chassis includes a drive frame portion and an engagement frame portion, wherein the drive frame portion and engagement frame portion selectively engage each other.

4. The transportation device of claim 1 wherein the handle pivotably height adjustable.

5. The transportation device of claim 1 wherein the handle includes a controller.

6. The transportation device of claim 1 wherein the chassis includes a support frame portion, a leg frame portion, a drive frame portion, and an engagement frame portion.

7. A transportation device comprising:
a first position comprising:
a chassis having a drive frame portion and an engagement frame portion;
a hoverboard;
wherein the hoverboard engages the engagement frame portion, the engagement engages the drive frame portion;
wherein the drive frame portion includes a drive system, the drive system communicates with the hoverboard to bypass a gyroscope; and
a second position comprising:
the drive frame portion disengaged from the engagement frame portion;
the chassis being folded along a longitudinal axis; and
the hoverboard engaged with the engagement frame portion.

8. The transportation device of claim 7 wherein the chassis further includes a handle.

9. The transportation device of claim 8 wherein the handle is height adjustable.

10. The transportation device of claim 9 wherein the handle is height adjustable through pivoting.

11. The transportation device of claim 8 wherein the handle includes a controller for adjusting an amount of assistance provided to the transportation device.

12. The transportation device of claim 7 wherein the transportation device includes a leg frame portion, the leg frame portion having wheel suspension extending therefrom.

13. The transportation device of claim 11 wherein the leg frame portion includes a footrest portion.

14. The transportation device of claim 12 wherein the footrest portion is height adjustable.

15. The transportation device of claim 7 wherein the chassis includes a seat portion and a back portion, the chassis further including adjustable arm rests.

16. The transportation device of claim 7 wherein the hoverboard and engagement frame portion engage through a hook and loop extending around the hoverboard.

17. A transportation device comprising:
a chassis including a seat portion and a back portion, the chassis further including a drive frame portion, an engagement frame portion, and a handle;
the drive frame portion having at least one frame segment;
the engagement frame portion having at least one engagement frame segment;
wherein the at least one frame segment selectively engages the at least one engagement frame segment; and
a hoverboard selectively engageable with the engagement frame portion.

18. The transportation device of claim 17 wherein the at least one engagement frame segment includes at least one engagement frame aperture and the at least one drive frame segment includes at least one drive frame aperture;
wherein at least one engagement frame segment is inserted into the at least one frame segment so that the at least one drive frame aperture and at least one drive frame aperture align with each other; and
a pin is inserted into the aligned at least one drive frame aperture and the at least one drive frame aperture to retain the at least one frame engagement segment and at least one frame segment engagement.

19. The transportation device of claim 17 wherein the transportation device includes a handle pivotably adjustable and further including a handle controller.

20. The transportation device of claim 17 wherein transportation device includes a brake extending from a leg portion of the chassis and selectively engages at least one hoverboard wheel.
